(19) United States
(12) Patent Application Publication
(10) Pub. No.: US 2006/0095778 A1
(43) Pub. Date: May 4, 2006

(54) Analog and digital indicia authentication

(76) Inventors: Duanfeng He, South Setauket, NY (US); William J. Callahan, Brookhaven, NY (US)

Correspondence Address: WATTS HOFFMANN CO., L.P.A., P.O. Box 99839, Cleveland, OH, 44199-0839, US

(21) Appl. No.: 10/977,597

(22) Filed: Oct. 29, 2004

(51) Int. Cl. H04L 9/00

(52) U.S. Cl. 713/180

(57) ABSTRACT

An authentication-enabled indicium contains authentication information in a digital recording medium. The information may be a digital signature that verifies the manufacturer's data and/or an analog signature. The analog signature is generated by placing a randomized pattern on a product package or label and encoding information about the randomized pattern in the digital recording medium for verification. The randomized pattern may be made up of color-shifting features imbedded in the label that are visible when illuminated with UV or infrared light. Characteristics of the reflected light when the features are illuminated is used to generate an analog signature that is encoded in the recording medium. During processing the features are illuminated and a new analog signature is determined for comparison with the signature recorded in the digital recording medium.

### FIELD OF THE INVENTION

The present invention relates to digital indicia readers and more particularly to a device for and method of authenticating an item using such a reader.

### BACKGROUND OF THE INVENTION

There is an increasing concern over counterfeit over-the-counter and prescription drugs entering the U.S. market. This concern is exacerbated because of the ready availability of lower cost prescription drugs from Internet pharmacies and drug stores with undisclosed sources for the product they provide. Counterfeit is increasingly an issue with respect to other types of goods such as software and music.

Many anti-counterfeit measures for use in drug and other types of merchandise such as CDs and DVDs have been developed. These anti-counterfeit measures attempt to prevent a counterfeit manufacturer from easily reproducing labels that bear the anti-counterfeit measures. For example, companies such as Microsoft® use holograms on the packages of their software to indicate authenticity. Escher Group in Cambridge, Mass. has developed a FiberFingerprint technology that can identify a piece of paper by its natural and unique fiber patterns. This enables the capability to identify a piece of paper in a way similar to identifying people through fingerprints. Tracer Technologies in Syosset, N.Y. has developed a fluorescent micro-fiber detection technology for security. The micro-fibers are randomly embedded in a plastic material and can only be revealed by UV light. AMCO in Farmingdale, N.Y. has developed visible as well as fluorescent tags that can be embedded in plastics. Other pigments that can be imbedded in an anti-counterfeit label change color when viewed at different angles, such as some used in the newly adopted U.S. currency. These technologies make it difficult to reproduce the anti-counterfeit label component using copying or scanning. Because counterfeiting is such a lucrative business, counterfeiters have been known to make the investment necessary to duplicate these anti-counterfeit measures. For example, the holographic labels many firms, such as Microsoft®, employ as an anti-counterfeit measure is widely known to have been successfully counterfeited.

### SUMMARY OF THE INVENTION

Authentication information is encapsulated in an authentication-enabled digital indicium to enable traditional indicia readers with little modification to provide a level of authentication during routine use. Analog authentication features may also be included with the authentication-enabled indicium for use with indicia readers that have hardware modifications. An analog authentication signature generated by previously scanning the analog authentication feature is encoded into the authentication-enabled indicium so that the analog authentication feature can be verified.

In one embodiment, the authentication-enabled indicium can be read by an unmodified indicia reader to provide non-authentication related information about the contents of the object bearing the label such as manufacturer, UPC number, quantity, and date of manufacture. The indicia reader software can be altered so that a digital signature that is encoded in the authentication-enabled indicium can be used to verify the authenticity of the label by accessing a stored signature key. In an exemplary embodiment, the indicia reader with modified hardware can also read the analog authentication feature and determine a corresponding analog signature and then compare the indicium's analog authentication signature with the analog authentication signature recorded in the authentication-enabled indicium.

Accordingly, an authentication-enabled indicium includes a digital recording medium, such as a bar code that has first and second data fields. The first data field encodes information about a product to which the indicium is affixed. The second data field encodes at least one authenticating signature that is verified by accessing information external to the digital recording medium. The indicium includes an analog identification region which contains a randomized pattern, that is separate from, but possibly adjacent to, the digital recording medium. The second data field encodes an analog authentication signature that is a summarization of some quality of the randomized pattern. one or both of the regions may advantageously form a part of a tamper-evident seal.

The randomized pattern can be made up of a plurality of identifiable features (such as fibers) that are randomly distributed in the analog identification region. The fibers may be color-shifting fibers that are detectable when illuminated by non-visible light. In this case, the second data field records an analog authentication signature that is computed from the analog identification region. The analog authentication signature can be, for example, a collection of data describing the identifiable features in the region, such as their location, size, and color. In an analog identification region design to contain approximately 20-30 identifiable features of the same size and color, the record could be the x and y coordinates of these features, a collection of 40-60 values. Boundary indicia including one or more orientation features are imprinted on the analog identification feature region to indicate an area of the analog identification region that corresponds to the analog authentication signature.

The authentication-enabled indicium's digital recording medium may have a third field that encodes a digital authentication signature that is verified against stored information. Alternatively, the digital authentication signature may be used in lieu of the analog authentication signature. The digital authentication signature is generated with information encoded in the first and/or second data fields using a secret key, and the digital authentication signature is verified using a corresponding public key. The public key may be stored in an indicia reader memory or in memory on an associated computer. Advantageously, the indicia reader may emit an alarm when one or more of the authentication measures cannot be verified.

These and other objects, advantages, and features of the exemplary embodiment of the invention are described in detail in conjunction with the accompanying drawings.

### BRIEF DESCRIPTION OF THE DRAWINGS

FIG. 1 is a schematic illustration of an indicia reader acting on a pharmaceutical container having an authentication-enabled indicium according to one embodiment of the present invention;

FIG. 1A is a schematic illustration of an alternative embodiment of the authentication-enabled indicium of FIG. 1;

FIG. 2 is a schematic illustration of information encoded in the authentication-enabled indicium of FIG. 1;

FIG. 3 is a schematic illustration of an indicia reader that has been modified according to one embodiment of the present invention to process authentication-enabled indicia; and

FIG. 4 is a flow chart illustrating a method that is used by the indicia reader to process authentication-enabled indicia according to one embodiment of the present invention.

### DETAILED DESCRIPTION

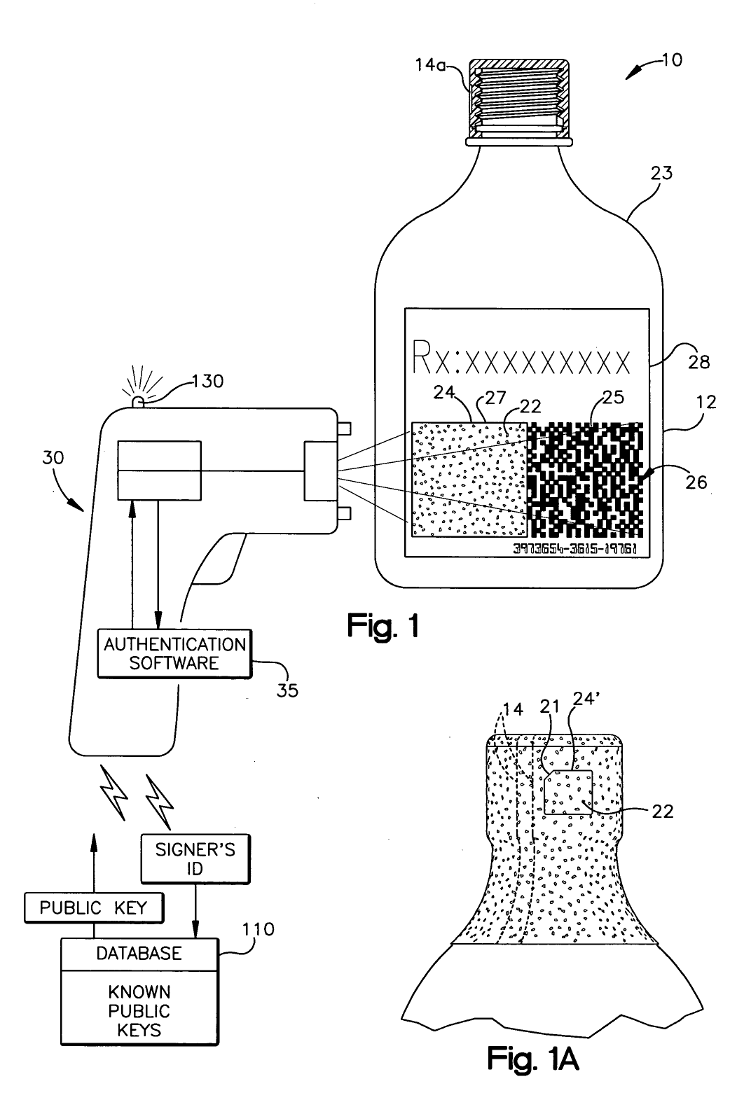

An authentication-enabled indicium combines analog and digital signatures as anti-counterfeit measures. Referring to FIGS. 1 and 1A, a schematic illustration of an enhanced indicia reader system 10 processing a pharmaceutical bottle 23 is depicted. An authentication-enabled indicium scanner 30 acts upon label 28 that features an authentication-enabled indicium 26. The authentication-enabled indicium 26 includes two components: an analog identification feature 24 and a digital recording medium that, for the purposes of this description, is a two dimensional bar code 25. One or both of these components can be used by the indicia reader to authenticate the source of the pharmaceutical bottle and its contents and may optionally be used to detect counterfeit goods.

Analog Identification Feature

In the described embodiment, the analog identification feature 24 is an indicia made of one or more types of colored features distributed in a random pattern. Some or all of the colored features may be color-shifting such that the features respond in a predictable way under a given illumination. One color-shifting characteristic that can be used is fluorescence, which generally refers to the excitation of visible light by means of invisible illumination. The use of color-shifting features prevents the use of photocopiers or scanners to reproduce the label. The use of colored features advantageously allows batches of label material to be produced in a normal process of making certain film or paper-like materials wherein the features would be randomly mixed in and survive intact throughout the remaining process. The label material can be made into tamper evident labels that are destroyed upon the opening of the bottle. Alternatively, the bar code portion of the indicium can form part of the security seal while the analog identification feature is part of the package such that removal of the seal destroys the connection between the two components of the indicium and prevents its reuse.

The analog identification feature is demarcated by an identification feature, here the outline 27 such that while the colored features may be located throughout the label 28, only the demarcated area is processed by the scanner as the analog identification feature. In another embodiment the identification feature 27 forms a virtual demarcation such that a predetermined (larger or smaller) area with respect to the identification feature is processed by the indicia reader as the analog identification feature. The identification feature 27 may be printed on the label material using a conventional printing process. While the shapes and relative sizes of the analog identification feature 24 and the digital indicium 26 are not important to the practice of the invention, it may be advantageous to size them similarly enough that their various components can be processed by the same optical device.

In the embodiment shown in FIG. 1, the analog identification feature 24 is located adjacent to the bar code 25. In another embodiment shown in FIG. 1A, the analog identification feature 24′ is remotely located from the bar code 25 and may be advantageously placed on a breakable packaging seal 14 such that tampering with the seal would disturb the analog identification feature causing detection of the tampering. In this embodiment the analog identifying feature 24′ includes an orientation feature 21 that may be necessary since a closely proximate digital bar code may not be available for the indicia reader to use to orient the analog identification feature. It is advantageous to include such an orientation mark because the analog signatures derived from the same area but different orientations could be different. Another advantage of such variations from simple geometrical shapes is that the identification mark is unlikely to be confused with common graphical design features found on product packages.

Any other randomly generated pattern that is difficult to reproduce using conventional methods may be used as the indicia of the analog identification feature. The pattern can be generated such that the features produce a unique signature for each indicium that would rarely, if ever, be reproduced in a like indicium. The randomness increases the likelihood of detection of strictly duplicated analog identification features. The randomness can be derived from a variety of factors, such as the location, size, or color of the features and if the features are long, such as fibers, the orientation of the fibers as well can be used to derive randomness.

For added protection against duplication, the features may be color-shifting such that they are visible in the presence of UV or infrared light, but nearly invisible when illuminated with visible light. One benefit of using color-shifting fibers is that the influence of post-production disfigurations (such as pieces of dirt), which are not normally color-shifting themselves, is reduced. Such disfigurations can be detected by comparing an image taken with UV or infrared light to one taken with visible light.

The indicia reader, in this case scanner 30 reads the analog identification feature 24 and determines an analog signature that is a numerical representation of some quality of the analog identification feature. For example, the signature can be a collection of data describing the identifiable features in the analog identification feature, such as the x y coordinates of a predetermined number of features having the same size and color. The signature is encoded in the digital bar code portion 25 of the authentication-enabled indicium 26 during manufacture of the label 28 for later authentication. A record of recently read signatures, or their representations, such as hashes, may be advantageously stored for comparison to the signature currently being processed to detect duplication of a random pattern among labels in the same batch of product.

Digital Indicium with Authentication Data

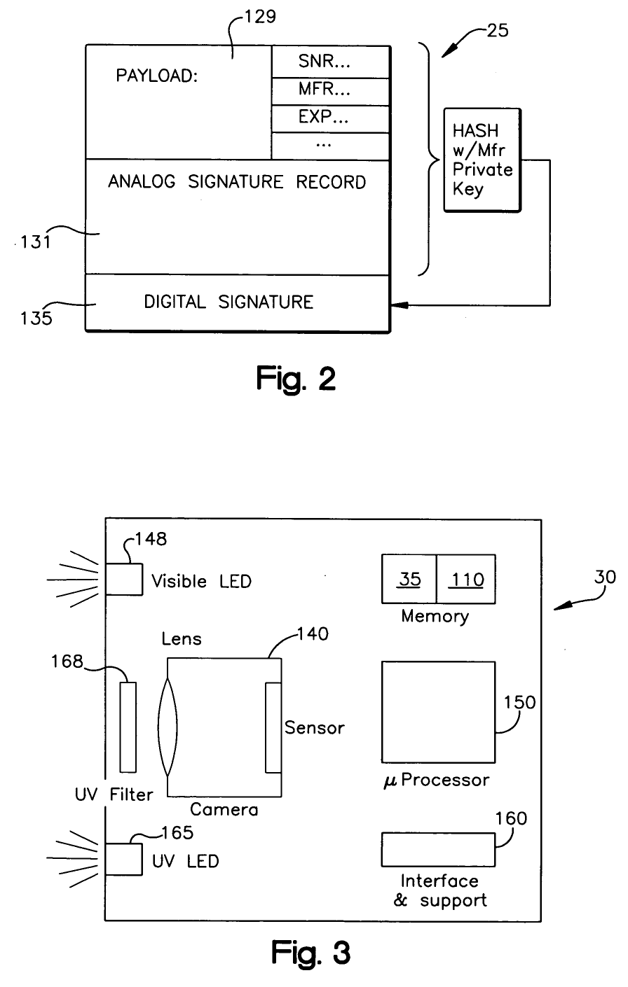

FIG. 2 is a schematic representation of the digital recording medium or bar code 25 of the authentication-enabled indicium 26. The bar code 25 encodes the manufacturer's identifying and specifying information, commonly referred to as the “payload” 129, a record of the analog signature 131, and a digital signature 135. The data is generally not encrypted, but advantageously uses error-correction to protect the reading integrity of the information it carries.

The payload 129 typically includes some or all of the following information: UPC/EAN number, manufacturer, part number, lot number, serial number, and expiration date. Identifiers usually identify each individual field or groups of fields according to given industrial standards. This portion of the bar code 25 can be read and processed by standard scanners in those situations where authentification is deemed unnecessary. The analog signature record 131 is tagged with an identifier similar to those used for the payload information.

The digital signature 135 that is encoded in the bar code 25 is a relatively common practice that is widely available in e-commerce and in almost every web browser. The NIST maintains a standard version, which is available for free. As shown in FIG. 2, the digital signature is a one-way hash of the message to which the signature is attached. In this case, the message is the information from the previous two subsections. The field identifiers themselves could be included as part of the message. The presence of the digital signature vouches for the authenticity of the information that is used to create the signature. The signer possesses a unique number for generating the one-way hash (secret or private key), and a published related number (the public key) is used to verify that the digital signature matches the message.

Indicia Reader for use with an Authentication-Enabled Indicium

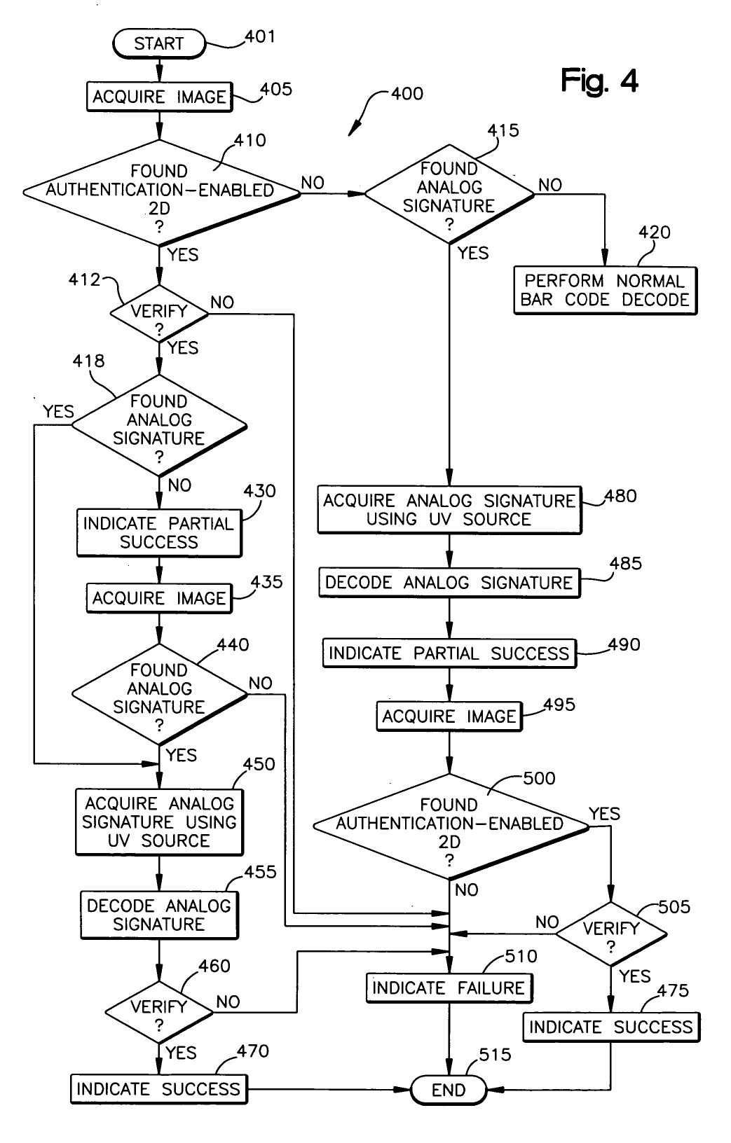

The indicia reader shown in FIG. 1 is a hand-held scanner, however the invention can be applied to stationary, hand-held computers, or standalone scanners alike. To process the authentication-enabled indicium, the scanner includes software 35 that follows the method 400 outlined in FIG. 4. The scanner can operate in one of several modes, allowing for varied degree of functionality depending on the capabilities of the scanner and its level of connectivity. The level of connectivity may be batch, where the scanner works without a connection to a PC and information such as scanning algorithms, methods for generating the analog signature and digital signature public key information are stored in on-board memory. The scanner may be connected to a computer or in connection with a wide-area-network. Three levels of scanner operation are possible depending on the modifications that have been made to the scanner. Data read only can be provided with a standard scanner that processes only the payload information and ignores unrecognized analog signature and digital signature information. In this way the authentication-enabled indicium is completely backward compatible. Digital authentication can be added by a scanner with upgraded software. A scanner with special hardware can perform a complete authentication, which includes analog and digital signature authentication.

Referring now to FIG. 4, which demonstrates the operations of an authentication scanner in a preferred embodiment, namely that of using a 2 dimensional bar code as the digital recording medium, and using a UV-light excitation for the observation of analog signature. Upon user activation, an image from the product is acquired in 405. The image is analyzed to determine if a two dimensional authentication enabled bar code is present in 410. If not, the image is analyzed at 415 to check for the presence of the identification mark of an analog signature. If neither an authentication enabled bar code nor the identification mark of analog signatures are detected the image is decoded in the standard fashion in 420. This branch of the software allows an authentication scanner to process non-authentication-enabled indicia.

If the identification mark of an analog signature is found in the image at 415 the analog signature is acquired in 480. As indicated in 480, if the observation of analog identification features requires specialized light, such as UV, that type of light is used to illuminate the indicium during reading. The analog identification features are processed in 485 to determine the analog signature based on the predetermined quality of the analog identification feature. A partial success is indicated at 490, while the analog signature is stored in the scanner memory.

After the indication of partial success in 490, signifying the success acquisition of the analog signature, the scanner, upon user activation, acquires another image in 495. In 500, the scanner attempts to find an authentication enabled 2 dimensional bar code. If it is not found as expected, it indicates a failure mode in 510, and ends the session in 515. If it does find the expected bar code, it authenticates both the analog and digital signatures in 505. If either of these fails, failure is indicated in 510. On the other hand, if both are verified, then success is indicated in 475, and the session ends in 515.

If an authentication enabled 2 dimensional bar code is found at 410 in 412, the digital signature is verified, using predetermined standard algorithm. If this verification fails, failure of authentication is indicated in 510, and the session ends in 515. If the verification succeeds in 412, the image is searched for the identification mark of the matching analog signature, in 418. If the identification mark of the matching analog signature is not found, a partial success is indicated in 430 to signify the success acquisition of the digital part of the indicium. Upon user activation, another image is acquired in 435. In 440, this new image is searched for the identification mark of the matching analog signature. If this step fails, failure is indicated in 510 and the session ends in 515. If the expected identification mark is found in 440, control passes to 450.

If the identification mark of the analog signature is found in 418, in 450, an image containing the analog signature is acquired using the UV light source. The analog signature is calculated in 455. In 460, this analog signature is verified against the analog signature record from 410. If this verification fails, failure is indicated in 510 and session ends in 515. However, if this verification succeeds, success is indicated in 470 and session again ends in 515.

Those in the art can easily embellish FIG. 4 in accordance to industry standard practices regarding scanners of bar codes. For example, from each user activation step to the point where the scanner determines that a code has not been properly acquired in the image in memory, one or more images could be acquired and decode attempted before a failure is declared. On the other hand, if one of these images is decoded successfully, the session (or half-session) is declared successful (or partially successful).

In 460 and 505, the analog signature is verified against its record with a user selectable degree of tolerance. For example, if the record in the bar code 25 contains the locations of 26 features, and the scanner can match 25 of these with the correct location, a success of authentication may be declared. Conversely, if only 15 matches are found, but 6 features with different locations (mismatches) are also observed, the scanner may indicate a failure of authentication.

If the analog identification feature includes color-shifting fibers, a specialized scanner such as that shown in FIG. 3 can be used to detect the color-shifting fibers. A camera 140 that includes a lens and a sensor (such as a CCD or CMOS 2-D array sensor), a UV block filter 168 that is in the light path of the camera either in front of or behind the lens, one or more visible LEDs 148, one or more UV LEDs 165, a micro-processor 150, a memory 35, which may contain the public key database 110, and interface and support circuits 160. The interface and support circuits 160 may have wired and/or wireless communications means to a host computer or a network. It may also contain an onboard battery (not shown), and/or connections for an external power supply (not shown).

The digital signature is verified in 505 and 412 using the manufacturer's public key. This key should be made available by the manufacturer. The key is usually obtained or verifiable through a trusted certificate agent. The key can be stored in a database 110 located in scanner memory (FIG. 3) or on an associated computer that is accessed by wireless or hard-wired connection (as shown in FIG. 1). Most scanners have sufficient on board memory to cache a number of public keys. Digital signatures are generally fixed for each manufacturer, with occasional changes in the event that it is retired due to special circumstances such as a merger or breach of security. It is thus generally safe to cache the key for a limited period of time. An expiration time is generally specified with the key, such as one year form the time of issuance or renewal. In this manner, partial success is indicated if either a digital or analog signature is present and verified and total success is indicated if both are present and verified. If either signature cannot be verified, the operator is alerted. This approach allows a degree of authentication to be provided without requiring hardware modifications for activating specialized features in the analog identification feature.

Alternative embodiments of the security device include using other digital media to record the same information that is recorded in the two dimensional bar code. For example, a magnetic device, or solid-state memory device (such as a memory button or a radio-frequency ID tag (RFID)) could be used.

Another embodiment includes a narrow band filter in place of the UV filter 168 (FIG. 3). The pass band of this filter is chosen to match that of the fluorescent light emitted. In addition, it also matches that of the visible LED. This is possible because there are different fluorescent materials that fluorescence in different wavelengths. And likewise, there are different LEDs that emit light in different wavelengths. By choosing a suitable fluorescent material and a type of LED that have common wavelengths, a filter can be constructed with a pass band that can allow both the light of the LED and the fluorescence of the features to pass through. Having a narrow band filter has the advantage that it can block out the majority of ambient light. Because fluorescent light is often weak, ambient light, if not blocked, could easily overwhelm it. Alternatively the scanner could work in contact mode, which uses parts of the scanner body to block out the ambient light.

It can be seen from the foregoing description, that including authentication features in a bar code can streamline the authentication process, make authentication features in labels difficult to copy or produce in counterfeit labels, and improve the detection of counterfeit goods. Although the invention has been described with a certain degree of particularity, it should be understood that various changes can be made by those skilled in the art without departing from the spirit or scope of the invention as hereinafter claimed.

I claim:

1. An authentication-enabled indicium comprising:
a digital recording medium including:
a first data field that encodes information about a product to which the indicium is affixed; and
a second data field that encodes at least one authenticating signature that is verified by accessing information external to the digital recording medium.

2. The authentication-enabled indicium of claim 1 comprising:
an analog identification region of the indicium that is separate from the digital recording medium that includes a randomized pattern; and
wherein the second data field encodes a record of analog authenticating signature that is a summarization of some quality of the randomized pattern.

3. The authentication-enabled indicium of claim 2 wherein the randomized pattern comprises a plurality of features that are randomly distributed in the analog identification region and wherein the second data field encodes an analog authentication signature that records the amount of light that is emitted by these features within the analog identification region.

4. The authentication-enabled indicium of claim 3 wherein the features are color-shifting features that are detectable when illuminated by non-visible light.

5. The authentication-enabled indicium of claim 2 wherein the randomized pattern comprises a plurality of features that are randomly distributed in the analog identification region and wherein the second data field encodes an analog authentication signature that is a location of one or more of the features.

6. The authentication-enabled indicium of claim 5 wherein the features are color-shifting features that are detectable when illuminated by non-visible light.

7. The authentication-enabled indicium of claim 2 comprising identification indicia imprinted on the analog identification region that indicates an area of the analog identification region that corresponds to the analog authentication signature.

8. The authentication-enabled indicium of claim 7 wherein the identification indicia include an orientation feature.

9. The authentication-enabled indicium of claim 1 wherein the digital recording medium is a two dimensional bar code.

10. The authentication-enabled indicium of claim 2 wherein the analog identification region is located adjacent to the digital recording medium.

11. The authentication-enabled indicium of claim 2 wherein one of the analog identification region and the digital recording medium is in close proximity to a tamper evident seal.

12. The authentication-enabled indicium of claim 2 wherein one of the analog identification region and the digital recording medium is part of a tamper evident seal.

13. The authentication-enabled indicium of claim 12 wherein the other one of the analog identification region and the digital recording medium is located remotely from the seal on the product to which the indicium is affixed.

14. The authentication-enabled indicium of claim 1 wherein the digital recording medium is a solid state memory device.

15. The authentication-enabled indicium of claim 1 wherein the digital recording medium is magnetic recording device.

16. The authentication-enabled indicium of claim 1 wherein the second data field encodes a digital signature that is verified against security information not stored in the digital recording medium.

17. The authentication-enabled indicium of claim 16 wherein the digital signature is based on information encoded in the first data field that is transformed using a secret key and wherein the digital signature is verified using a corresponding public key.

18. The authentication-enabled indicium of claim 2 comprising a third data field that encodes a digital signature, signed by a party designated in the digital recording medium that verifies data in the first and second data fields.

19. The authentication-enabled indicium of claim 2 wherein the randomized pattern displays different qualities when excited with an invisible stimulation source.

20. A method that authenticates an indicium that includes a digital recording medium comprising:
decoding a first data field having information about a product to which the label is affixed;
decoding a second data field having at least one authentication signature that is verified by accessing information external to the indicium;
verifying the authenticating signature using information not encoded in the digital recording medium.

21. The method of claim 20 wherein the authenticating signature is an analog authentication signature and wherein the analog authentication signature is verified by causing an indicium reader to act upon an analog identification feature on the product and generating an analog signature based on a predetermined set of qualities of the analog identification feature and comparing the generated analog signature to a record of itself encoded in the second data field.

22. The method of claim 21 comprising subjecting the analog identification feature to non-visible light excitation while causing the indicium reader to act upon the analog identification feature.

23. The method of claim 21 wherein one of the analog signature and the record of the analog signature were generated in previous readings.

24. The method of claim 20 wherein the authentication signature is a digital authentication signature and wherein the digital authentication signature is verified by accessing security information stored outside the digital recording medium.

25. The method of claim 24 wherein the digital signature comprises information encoded in the first data field that has been encrypted using a secret key and wherein the digital authentication signature is verified using a corresponding public key.

26. The method of claim 21 comprising decoding a third data field that includes digital authentication signature based on information in both the first and second data fields and wherein the digital authentication signature is verified by accessing security information stored outside the digital recording medium.

27. The method of claim 26 wherein the digital signature comprises information encoded in the first data field that has been encrypted using a secret key and wherein the digital signature is verified using a corresponding public key.

28. The method of claim 25 wherein the public key is stored in a scanner memory.

29. The method of claim 25 wherein the public key is stored in a computer located remotely from a scanner that acts on the indicium.

30. The method of claim 20 comprising issuing an alarm when the signature cannot be verified.

31. The method of claim 23 comprising indicating a partially successful scan when either the digital signature is successfully verified or the analog authentication signature is successfully captured, and wherein the verification of the other one of the analog authentication signature and digital signature is delayed until a subsequent reading of an unread portion of the same indicium.

32. The method of claim 21, comprising keeping at least one recently captured analog authentication signature, or a digital representation of it, in memory, comparing it with the record of analog signature from the current scan, and indicating a warning when the latter is found to be identical to one or more of recently captured analog authentication signatures kept in memory.

33. An authentication indicium reader comprising:
a visible light source,
a camera containing a lens system and a two-dimensional sensor array,
a memory,
and a processor which performs authentication by capturing the image of a two-dimensional bar code and authenticating it with information stored outside of the bar code.

34. The authentication scanner of claim 33 which further contains an invisible light source for exciting one or more analog identification features into giving out fluorescent light for capturing by the camera, and wherein the processor authenticates the analog identification features by comparing an analog signature derived from these features with a record of the analog signature found in the data of the two-dimensional bar code.

35. The authentication scanner of claim 34 comprising an indicator that is caused to indicate a partial successful scan by the processor when one of the analog signature and the two-dimensional bar code is successfully scanned.

36. The authentication scanner of claim 34 wherein the scanner stores record of the partial successful scan in memory and awaits user activation for subsequent scanning of the other of the analog signature and the two-dimensional bar code.

37. The authentication scanner of claim 34 wherein the visible light source gives out light with substantially the same wavelength as fluorescent light that is emitted from the analog identification features and wherein the scanner further comprises a band pass filter that filters out substantially all of the ambient light except for light with a wavelength similar to the emitted fluorescent light wavelength.

38. The authentication scanner of claim 34 wherein the scanner stores at least one recently captured analog authentication signature, or a digital representation of it, in memory, compares it with the record of analog signature from the current scan, and indicates a warning when the latter is found to be identical to one or more of recently captured analog authentication signatures kept in memory.

39. An authentication scanner comprising:
a visible light source,
an invisible source of excitation,
a camera containing a lens system and a two-dimensional sensor array,
a digital data readout device,
a memory,
and a processor which performs authentication by reading out information of a digital recording medium, and capturing images, with both the visible and invisible source, of analog identification features, authenticating the digital medium with the analog identification features.
